(19) United States
(12) Patent Application Publication
(10) Pub. No.: US 2015/0161351 A1
(43) Pub. Date: Jun. 11, 2015

(54) METHODS AND SYSTEMS FOR PRESCRIPTION MANAGEMENT

(71) Applicant: LOUIS A. SCALPATI, Austin, TX (US)

(72) Inventor: LOUIS A. SCALPATI, Austin, TX (US)

(73) Assignees: RXWIKI, INC., Austin, TX (US); LOUIS A. SCALPATI, Austin, TX (US)

(21) Appl. No.: 14/562,869

(22) Filed: Dec. 8, 2014

Related U.S. Application Data
(60) Provisional application No. 61/914,351, filed on Dec. 10, 2013.

(51) Int. Cl. G06F 19/00

(52) U.S. Cl. CPC G06F 19/3456; G06F 19/322

(57) ABSTRACT

Embodiments disclosed herein provide systems and methods that utilize a set of tool-kits wrapping around refill systems associated with pharmacies to create a common application program interface (API). The common API allows a medical patient to utilize a single interface to manage prescriptions at a plurality of independent pharmacies.

### CROSS-REFERENCE TO RELATED APPLICATIONS

This application claims a benefit of priority under 35 U.S.C. §119 to Provisional Application No. 61/914,351 filed on Dec. 10, 2013, which is fully incorporated herein by reference in its entirety.

### BACKGROUND INFORMATION

1. Field of the Disclosure

Examples of the present disclosure relate to techniques for medical patients to manage prescriptions from different providers and pharmacies. More particularly, embodiments are related to consumer-centric systems and methods allowing medical patients to manage prescriptions associated with different pharmacies via a common interface.

2. Background

Conventionally when filing a prescription, a medical patient obtains a written prescription to address a medical patient's illness for a drug from a physician. The medical patient carries the physical prescription to a pharmacy. At the pharmacy, the medical patient may provide the pharmacy with information to fill the prescription. If the medical patient desires to refill the prescription, the medical patient must revisit the pharmacy, which has the information to refill the prescription

More so, different pharmacies have independent software systems allowing medical patients to fill and refill their prescriptions. Yet these conventional software systems associated with the different pharmacies have different requirements concerning the required information to fill a prescription. Furthermore, these conventional software systems associated with different pharmacies have different features or capabilities.

Therefore, the task of a medical patient managing multiple, independent software applications for different pharmacies may be daunting and inefficient if a medical patient has multiple prescriptions at multiple pharmacies or desires to change pharmacies.

Additionally, situations may arise where the medical patient desires to fill a prescription at a new pharmacy. Conventionally to fill the prescription at the new pharmacy, the medical patient may be required to carry a new physical prescription to the new pharmacy, re-provide the new pharmacy with the information to fill the prescription, and have the new pharmacy review the prescription history of the medical patient. This is an inefficient way to fill prescriptions when the medical patient has already supplied the desired information to fill the prescription.

Accordingly, needs exist for more efficient and effective methods and systems allowing medical patients to manage and initiate new prescriptions across different platforms associated with different pharmacies.

### SUMMARY

Embodiments disclosed herein provide a consumer-centric system and methods for medical patients to manage prescriptions associated with different pharmacies via a common Application Program Interface (API).

Embodiments utilize a set of tool-kits that wrap around the different pharmacies' refill systems to create the common API, wherein the common API corresponding to the APIs associated with each of the different pharmacies. In embodiments, the different pharmacies may have prescription management systems that are unassociated with one another, require different information, and have different information. The common API is configured to allow the medical patient to utilize a single interface to manage prescriptions at a plurality of independent pharmacies.

In embodiments, protocols may be received from a plurality of independent pharmacies defining the pharmacies' API and indicating how the pharmacies' refill software API operates. Responsive to determining the protocols associated with the different, independent pharmacies, the protocols may be wrapped with a set of functions to create the common API. The common API may be configured to receive data from a medical patient to allow the medical patient to manage prescriptions at different pharmacies via a server engine.

In embodiments, the server engine may include a plurality of memory devices including configuration memory devices, pharmacy memory devices, and a consumer memory device. The common API may be configured to receive information stored on the different memory devices to determine 1) what information is required to fulfill a prescription or refill at a selected pharmacy based on previous information entered by a user, 2) a feature set associated with the selected pharmacy, and 3) only present fields associated with information that the selected information is not able to retrieve from the memory devices.

Therefore, new pharmacies may be dynamically added to a list of pharmacies that the medical patient may select to fill a prescription or refill without the user having to enter redundant information, and without the pharmacy having to receive information directly from the medical patient.

The configuration memory device may be associated with a different API associated with protocols at a pharmacy. The pharmacy memory devices may be configured to link the specific pharmacies and their corresponding API. The consumer memory device may be configured to store with the biographical information associated with medical patients, personalized attributes of the medical patients, and the refill history of the medical patients.

In embodiments, the server engine may be configured to communicate data with client computing devices, wherein the client computing devices are operated by the medical patients. Using a client computing devices, the medical patient may utilize the common API to communicate data between a first pharmacy and a second pharmacy. The data may be communicated via the common API so that the medical patient may manage prescriptions for the different pharmacies, and use new pharmacies to refill prescriptions without having to redundantly enter or communicate data to specific, individual pharmacies.

Additionally, via the common API, the server engine may be configured to perform prescription management operations, such as: transmitting reminders associated with prescriptions at the multiple pharmacies to the client computing device associated with the medical patient, receiving information associated with drug interactions from a pharmacist, medical practitioner, and/or the medical patient, etc. Therefore, the functions of each of the pharmacies individual APIs may be utilized via the common API, such that the medical patient may manage their prescriptions via a common interface.

In embodiments, utilizing the common API, a medical patient may seamlessly transfer a prescription from a first pharmacy to a second pharmacy, if the medical patient has previously entered information associated with the new pharmacy. To this end, upon receiving a request to transfer a prescription from the first pharmacy to the second pharmacy, the common API may determine that all required information is currently stored on memory devices. Responsive to the determination, the common API may automatically fulfill the prescription at the second pharmacy without receiving any additional information from the medical patient other than the request to transfer the prescription.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified

FIG. 1 depicts an embodiment of a consumer centric topology configured to allow a medical patient to communicate with a plurality of pharmacies' APIs.

FIG. 2 depicts an embodiment of a method allowing a medical patient to utilize a common API associated with a plurality of pharmacies to fill a prescription over a network

FIG. 3 depicts an embodiment of a method allowing a medical patient to switch a prescription being filled at a first pharmacy to a having a prescription being filled at a second pharmacy.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

The systems and methods disclosed herein utilize a set of tool kits that wrap around different pharmacies refill systems to create an application program interfaces (API) corresponding to each pharmacy. The API allows the medical patient to utilize a single interface to manage prescriptions at a plurality of independent pharmacies.

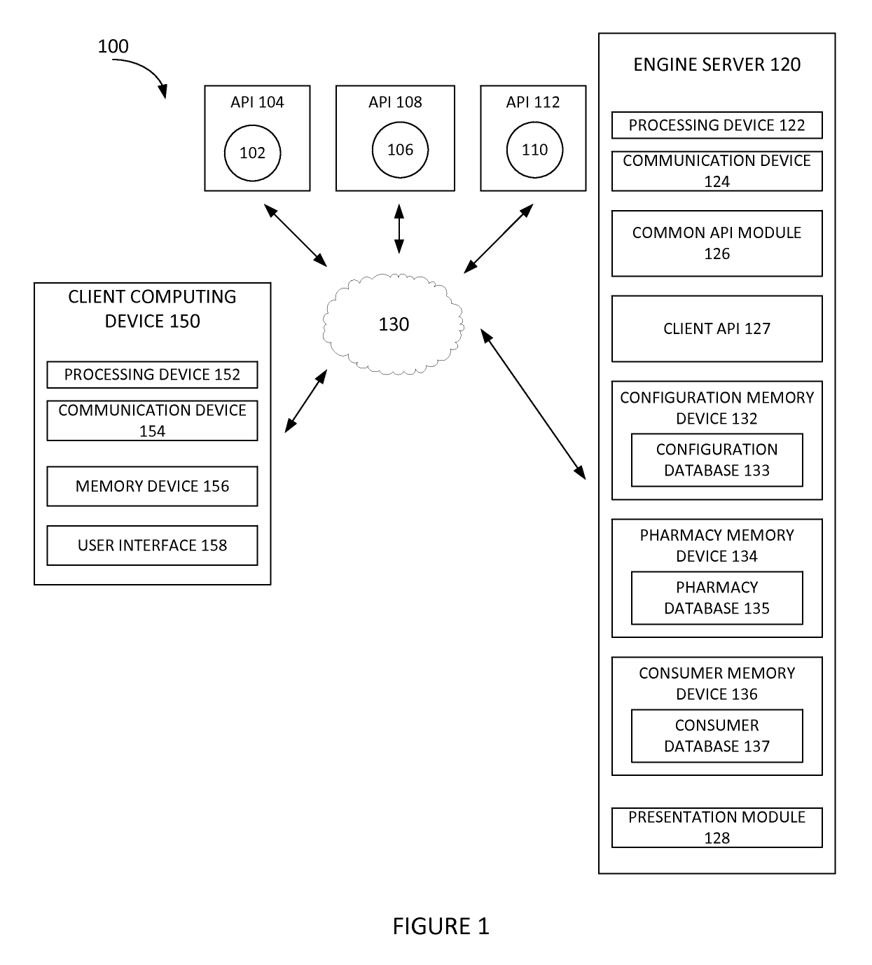

Turning now to FIG. 1, FIG. 1 depicts one consumer centric topology 100 configured to allow a medical patient to communicate with a plurality of pharmacies' APIs, each having different configurations, parameters, settings, and/or functions, via a single interface to manage their prescriptions.

Topology 100 may include a plurality of pharmacies 102, 106, 110, an engine server 120, and a client computing device 150. The elements depicted in topology 100 may be communicatively coupled to each other over network 130.

Network 130 may be a wired or wireless network such as the Internet, an intranet, a LAN, a WAN, a cellular network or another type of network. It will be understood that network 130 may be a combination of multiple different kinds of wired or wireless networks where data may be communicated with different protocols or standards.

Pharmacies 102, 106, 110 may be hardware processing devices associated with an individual pharmacy or a chain of pharmacies. For example, a pharmacy chain may be Walgreens, CVS, etc., with different physical pharmacies. In embodiments, a pharmacy may be any location that fills prescriptions responsive to the medical patient and/or a medical practitioner communicating a prescription to the pharmacy. One skilled in the art will appreciate that the term pharmacy may refer to a drugstore, convenient store, hospital, etc.

In embodiments, each pharmacy 102, 106, 110 may have a respective API 104, 108, and 112, where each API 104, 108, and 112 may have different protocols, features, and/or desired information to fill a prescription. In embodiments, APIs 104, 108, and 112 may be configured to: determine 1) protocols for pharmacies 102, 106, and 110 to fill a prescription, 2) what features are provided to refill prescriptions, and 3) information required to refill a prescription.

For example, in one embodiment a first pharmacy 102 may be able to refill a prescription responsive to API 104 receiving data associated with a scanned bar code, where API 108 associated with second pharmacy 106 may not include this feature. Additionally, API 104 associated with first pharmacy 102 may require receiving a social security number associated with the medical patient to refill the medical patient's prescription. Whereas, API 108 associated with second pharmacy 106 may not require receiving a social security number associated with the medical patient to fill the persecution, and API 109 may only require receiving a legal name and address of the medical patient to refill the medical patient's prescription. Further features associated with APIs 104, 108, 112 may include prescription management functions, such as transmitting reminders to refill prescriptions, receiving information associated with drug intake, etc. Accordingly, the different APIs 104, 108, 112 may each require different sets of information to fill a prescription, and/or have different feature sets.

Engine server 120 may be a computing device, such as a general hardware platform server configured to support mobile applications, software, and the like executed on APIs 104, 108, 112 and/or client computing device 150. Engine server 120 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Engine server 120 may include any combination of one or more computer-usable or computer-readable media. For example, engine server 120 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

In embodiments, engine server 120 may be a community pharmacy network, including: a processing device 122, a communication device 124, a common API module 126, a client API 127, a configuration memory 132 device associated with each of the plurality of pharmacies' APIs, a pharmacy memory device 134 linking the specific pharmacies to their corresponding API, and a consumer memory device 136 associated with personalized attributes of patients and refill history of the patient, and a presentation module 128.

Processing device 122 may include memory, e.g., read only memory (ROM) and random access memory (RAM), storing processor-executable instructions and one or more processors that execute the processor-executable instructions. In embodiments where processing device 122 includes two or more processors, the processors may operate in a parallel or distributed manner. Processing device 122 may execute an operating system of engine server 120 or software associated with other elements of engine server 120.

Communication device 124 may be a device that allows engine server 120 to communicate with another device over network 130. Communication device 124 may include one or more wireless transceivers for performing wireless communication and/or one or more communication ports for performing wired communication.

Common API module 126 may be a hardware processing device configured to: communicate data to and from APIs 104, 108, and 112 according to a protocol associated with the respective API 104, 108, and/or 112, dynamically determine a feature set and required information to refill a prescription via APIs 104, 108, 112, and generate data to be presented on client computing device 150. In embodiments, common API module 126 may generate a common API such that a medical patient may manage their prescriptions for different pharmacies and use new pharmacies to refill their prescriptions without having to independently communicate data to plurality of pharmacies 102, 106, 110. Additionally, common API module 126 may be configured to: receive an identifier associated with a medical patient, receive an identifier for at least one prescription associated with the medical patient, determine what pharmacy 102, 106, or 108 is associated with corresponding prescriptions, determine a history of the medical patient based on a time a prescription was filled and a pharmacy where the prescription was filled, determine what information is desired for the corresponding APIs 104, 108, and 112 to fill a prescription, communicate a request for the desired information to the determined pharmacy 102, 106, or 108, and determine a feature set associated with APIs 104, 108, and 112. Therefore, the common API module 126 may allow a medical patient utilizing client computing device 150 to manage prescriptions from a plurality of pharmacies 102, 106, 110.

In further embodiments, responsive to determining a selected pharmacy to fill a prescription, common API module 126 may generate an interface that includes only the feature set and the fields for desired information to fill the prescription for the API associated with the selected pharmacy. Therefore, the medical patient may only have to enter or communicate the desired information to fill the prescription without having to enter or communicate redundant, additional, or unnecessary information.

For example, first pharmacy 102 with API 104 may allow the medical patient to fill a prescription via entering a code associated with the prescription or scanning a barcode associated with the prescription, and second pharmacy 106 with API 108 may only allow the medical patient to fill the prescription via entering a code associated with the prescription. If the medical patient desires to fill the prescription with the second pharmacy 106, then only the option to fill the prescription via the code will be presented to the medical patient. To this end, the interface may present only the necessary or desired information to fill a prescription, without creating an interface inundating the medical patient with fields requesting unnecessary information to manage their prescriptions at multiple pharmacies.

Client API 127 may be an API configured to communicate data with client computing devices 150, such that client API 127 may be integrated into a third-party website or mobile application. Client API 127 may allow third-party developers utilizing client computing devices 150 to utilize engine server 120 for refills and other transactions. In embodiments, client API 127 may be a single, universal API allowing third-parties to access the front-end of engine server 120, wherein client API 127 may manage data interchanges and transactions performed by common API module 126 with APIs 104, 108, and 112. Accordingly, a third-party developer may utilize the common API to determine data that should be transmitted to consumers along with prescriptions information, such as news articles, prescriptions management, etc. associated with a prescription transmitted to a user's client computing device 150. Furthermore, third-party developers may create applications that create entries within configuration memory device 132 and/or pharmacy memory device 134. Therefore, a plurality of third-party developers and applications may access engine server 120. Configuration memory device 132 may be a device that stores information associated with APIs 104, 108, and 112. Configuration memory device 132 may include, but is not limited to a hard disc drive, an optical disc drive, and/or a flash memory drive. In embodiments, configuration memory device 132 may include a configuration database 133, which may be a registry, configured to store an identifier for pharmacies 102, 106, and 110, protocols supported by APIs 104, 108, and 112, required information from medical patient for APIs 104, 108, and 112 to fill a prescription, and feature sets supported by APIs 104, 108, and 112.

The identifier associated with pharmacies 102, 106, and 110 may be a name, code, or any other unique identifier. The required information for APIs 104, 108, and 112 may be the information required from the medical patient for corresponding pharmacies 102, 106, and 110 to fill a prescription for the medical patient. In embodiments, the required information may include a name of the medical patient, contact information of the medical patient, an identifier of the prescription to be filled, a name of the doctor prescribing the prescription etc. One skilled in the art will appreciate that the required information may be different for each API 104, 108, and 112. The feature sets supported by APIs 104, 108, and 112 may be different ways that a medical patient may provide the required information. In embodiments, the feature sets may include an interface to scan a barcode or QR code associated with a prescription, an interface configured to receive a code associated with a prescription, etc. One skilled in the art will appreciate that the feature sets may be different for each API 104, 108, and 112.

Pharmacy memory device 134 may be a device configured to store information associated with pharmacies. The information associated with the pharmacies may be configured to allow common API module 126 to link the identifier of a pharmacy 102, 106, 110 to information associated with a corresponding pharmacy, wherein the identifier is stored within configuration memory device 132. Pharmacy memory device 134 may include, but is not limited to a hard disc drive, an optical disc drive, and/or a flash memory drive. In embodiments, pharmacy memory device 134 may include pharmacy database 135. Pharmacy database 135 may include the unique identifiers associated with pharmacies 102, 106, 110 and location information associated with the pharmacies 102, 106, 110. The location information may be associated with and represented in geographic coordinates, Cartesian coordinates, and/or a name of pharmacy 102, 106, or 110. In embodiments, engine server 120 may receive location data such as real-time locating system signals (RTLS), WiFi signals, GPS, Bluetooth, short range radio signals, etc. from client computing device 150.

In embodiments, engine server 120 may be configured to determine the location data of client computing device 150 responsive to a medical patient logging into a software application associated with engine server 120, and determine the closest pharmacies 102, 106, and 110 to client computing device 150 based on the received location data of client computing device 150 and the location information associated with pharmacies 102, 106, and 110 stored within pharmacy database 135. The name of the closest determined pharmacies 102, 106, and 110 may be transmitted to and presented on client computing device 150. In embodiments, the closest determined pharmacies may be any pharmacy within any desired distance from client computing device 150.

Consumer memory device 136 may be a device configured to store information associated with a medical patient. Consumer memory device 136 may include, but is not limited to a hard disc drive, an optical disc drive, and/or a flash memory drive. In embodiments, consumer memory device 136 may include consumer database 137. Consumer database 137 may include a user profiles associated with medical patients. The user profiles may include, for example, information identifying users, such as a username or handle, a number, an identifier, and/or other identifying information, security login information, such as, a login code or password, biography information associated with medical patient, health insurance information, default pharmacy information indicating a default pharmacy for the medical patient, prescription information associated with drugs that the medical patient is taken or previously taken, refill information associated with what drugs the medical patient is eligible for a prescription refill, refill timing information associated with when a refill for a drug may be made available to the patient, and pharmacy information indicating what prescriptions the medical patient is taking or has previously taken at a pharmacy, etc.

Presentation module 128 may be configured to transmit information configured to be displayed on a graphical user interface of client computing device 150. Presentation module 128 may transmit information associated with filling a prescription at pharmacy 102, 106, 110 to client computing device 150. In embodiments, the transmitted information may only include the desired information to fill a prescription for a selected pharmacy and the feature set associated with the API for the selected pharmacy. Therefore, the medical patient may not receive requests for information associated with unnecessary information. Furthermore, presentation module 128 may be configured to dynamically change the graphical user interface presented on client computing device 150 based on what pharmacy is selected. Accordingly, based on the APIs associated with a first and second pharmacy, a first graphical user interface may be presented to a medical patient when the medical patient requests a prescription be filled at a first pharmacy, and a second graphical user interface may be presented to the medical patient when the medical patient requests a prescription be filled at the second pharmacy.

Client computing devices 150 may be a smart phone, tablet computer, laptop computer, wearable computer, personal data assistant, or any other type of mobile device with a hardware processor that is configured to process instructions and connect to network 130, one or more portions of network 130. Client computing devices 150 may include processing device 152, communication device 154, a memory device 156, and a user interface 158.

Processing device 152 can include memory, e.g., read only memory (ROM) and random access memory (RAM), storing processor-executable instructions and one or more processors that execute the processor-executable instructions. In embodiments where processing device 152 includes two or more processors, the processors may operate in a parallel or a distributed manner. Processing device 152 may execute an operating system of client computing device 150 or software associated with other elements of client computing device 150.

Communication device 154 may be a device that allows client computing device 120 to communicate with another device, e.g., engine server 120 over network 130. Communication device 154 may include one or more wireless transceivers for performing wireless communication and/or one or more communication ports for performing wired communication.

Memory device 156 may be a device configured to store data generated or received by client computing device 150. Memory device 156 may include, but is not limited to a hard disc drive, an optical disc drive, and/or a flash memory drive. Memory device 156 may be configured to store data associated with a medical patient's profile, or any other information transmitted to or received from engine server 120.

User interface 158 may be a device that allows a user to interact with client computing device 150 or engine server 120 over network 130. While one user interface is shown, the term “user interface” may include, but is not limited to being, a touch screen, a physical keyboard, a mouse, a camera, a video camera, a microphone, and/or a speaker. Utilizing user interface 158, the user may select a pharmacy to refill a prescription, fill in fields for an API where engine server 120 has indicated are required to refill the prescription, or interact with engine server 120 over network 130.

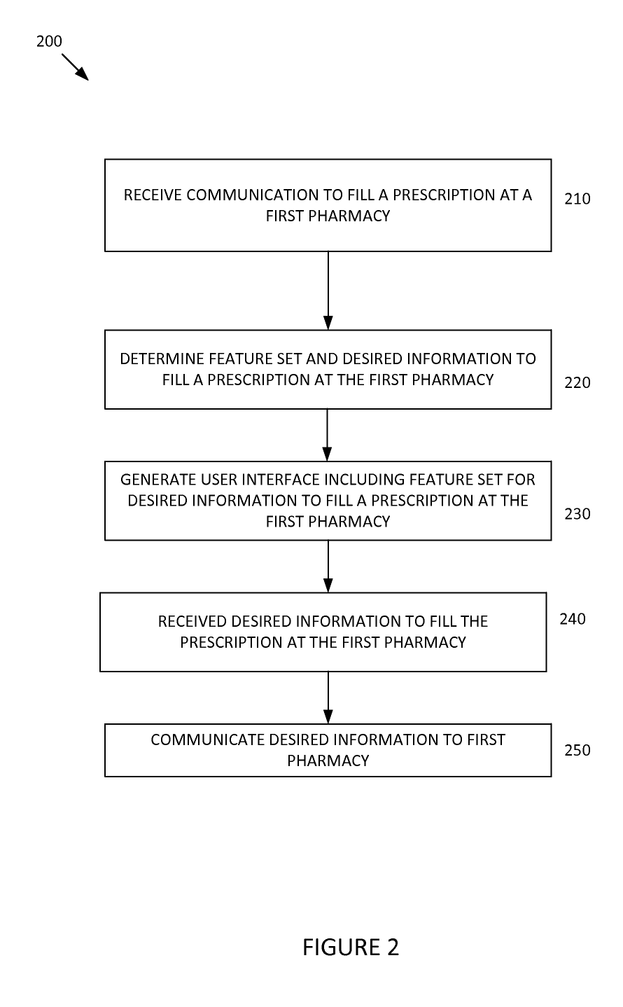

FIG. 2 illustrates a method 200 allowing a medical patient to utilize a common API associated with a plurality of pharmacies to fill a prescription over a network. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At operation 210, a communication indicating that a medical patient desires to fill a prescription at a first pharmacy may be received. The received communication may include an identifier of the medical patient and an identifier the first pharmacy. Operation 210 may be performed by a communication device that is the same as or similar to communication device 124, in accordance with one or more implementations.

At operation 220, a feature set and desired information to fill a prescription for the first pharmacy may be dynamically determined based on the identifier of the first pharmacy within the received communication at operation 210. Responsive to receiving the communication, the feature set and desired information to fill a prescription for the first pharmacy may be determined by parsing a database including identifiers of pharmacies and their corresponding feature sets, desired information to fill a prescription, and communication protocol. Upon matching an identifier of the first pharmacy with an identifier of the pharmacies within the database, the feature set and desired information to fill the prescription for the first pharmacy may be set as the corresponding feature set and desired information within the database associated with the matching identifiers. Operation 220 may be performed by a common API module that is the same as or similar to common API module 126, in accordance with one or more implementations.

At operation 230, a graphical user interface configured to be displayed on a client device may be generated. The generated user interface may include the feature set and desired information to fill a prescription for the first pharmacy. Operation 230 may be performed by a presentation module that is the same as or similar to presentation module 128, in accordance with one or more implementations.

At operation 240, a communication including the desired information to fill a prescription based on the feature set of the first pharmacy may be received from the client computing device associated with the medical patient, wherein the communication may only include a request for information that the user has not previously entered associated with other pharmacies. Operation 240 may be performed by a communication device that is the same as or similar to communication device 124, in accordance with one or more implementations.

At operation 250, the desired information desired to refill a prescription may be translated into a protocol associated with an API of the first pharmacy. The translated information may be communicated to the API of the first pharmacy over a network. In embodiments, the protocol associated with the first pharmacy may be a markup language used for structuring and presenting content over the internet, such as HTML, HTML5, XML, etc. Operation 250 may be performed by a common API module that is the same as or similar to common API module 126, in accordance with one or more implementations.

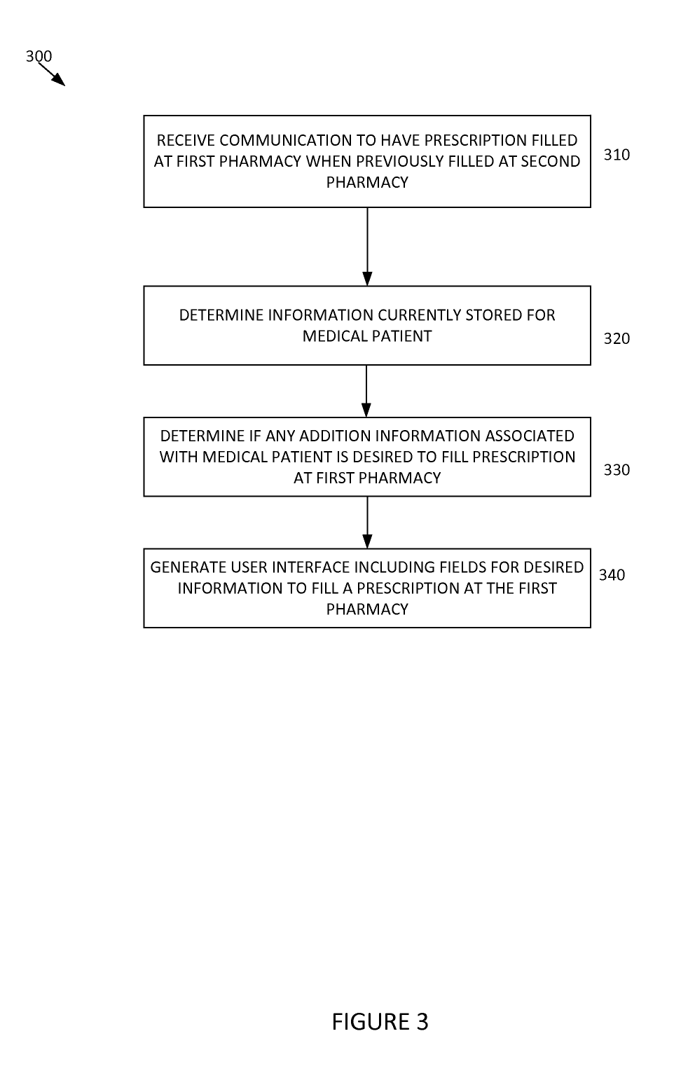

FIG. 3 illustrates a method 300 allowing a medical patient to switch a prescription being filled at a first pharmacy to a having a prescription being filled at a second pharmacy. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At operation 310, a communication indicating that a medical patient desires to refill a prescription at a first pharmacy may be received, wherein the medical patient had previously had the prescription filled at a second pharmacy. The received communication may include an identifier of the medical patient, an identifier the first pharmacy, and information associated with the prescription, such as type of drug, date eligible for refill, quantity, dosage, etc. . . . . Operation 310 may be performed by a communication device that is the same as or similar to communication device 124, in accordance with one or more implementations.

At operation 320, it may be automatically determined what biographical information associated with the medical patient is stored within a medical patient database, without receiving a further communication from the medical patient. The additional information may be determined by parsing the medical patient database including identifiers of the medical patient and biographical information of medical patients. Upon matching the received identifier within the communication at operation 310 with an identifier of a medical patient within the medical patient database, it may be determined what biographical information associated with the medical patient is stored within the medical patient database. Operation 320 may be performed by a common API module that is the same as or similar to common API module 126, in accordance with one or more implementations.

At operation 330, it may be automatically determined if any additional information is desired from the medical patient to have the prescription refilled at the first pharmacy. Responsive to receiving the communication, the desired biographical information to fill a prescription at the first pharmacy that was not previously entered when the medical patient filled the prescription at the second pharmacy may be determined. The determination may be completed by parsing a database including identifiers of pharmacies and their corresponding desired biographical information to fill a prescription. Upon matching an identifier of the first pharmacy with an identifier of the pharmacies within the database, the biographical information desired to fill the prescription at the first pharmacy may be determined. By comparing the desired biographical to fill the prescription at the first pharmacy and the biographical information associated with the medical patient stored within the medical patient database that was entered when the medical patient was previously filling prescriptions it may be determined if additional biographical information is required from the medical patient. Operation 330 may be performed by a common API module that is the same as or similar to common API module 126, in accordance with one or more implementations.

At operation 340, a graphical user interface configured to be displayed on a client device may be generated. The generated user interface may include fields indicating the desired biographical to fill a prescription for the first pharmacy. If the desired biographical information for the medical patient associated with a field is stored within the medical patient database, then the field may be pre-populated. However, if the desired biographical information for the medical patient associated with a field is not stored within the medical patient database, the field may include an interface allowing the medical patient to enter the desired biographical information associated with the field. In implementations where the additional biographical information is required to fulfil the prescription at the first pharmacy, the prescription may automatically be fulfilled at the first pharmacy without receiving other information from the medical patient. Operation 340 may be performed by a presentation module that is the same as or similar to presentation module 128, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A system for managing prescriptions, the system comprising:
a communication device configured to receive Application Programming Interfaces (API) from a plurality of pharmacies, the APIs requiring different sets of information to fulfill a prescription and the APIs including different feature sets, wherein the plurality of pharmacies are not associated with one another;
a configuration memory device configured to store first configuration information for a first API associated with a first pharmacy and a first identifier associated with the first pharmacy, wherein the first pharmacy is one of the plurality of pharmacies;
a consumer memory device configured to store a first profile associated with a medical patient;
a common API module configured to,
receive a first prescription identifier associated with a prescription for the medical patient,
determine that the first prescription identifier is associated with the first pharmacy,
determine a first set of medical patient information required to fulfill the prescription at the first pharmacy based on the first configuration information, and
determine information associated with the first set of medical patient information required to fulfill the prescription is within the first profile; and
a presentation device configured to present a first feature set associated with the first pharmacy based on the first configuration information, and present the first set of medical patient information required to fulfill the prescription.

2. The system of claim 1, wherein the communication device is configured to receive a second prescription identifier for the medical patient;
the configuration memory device configured to store second configuration information for a second API associated with a second pharmacy and a second identifier associated with the second pharmacy, wherein the second pharmacy is one of the plurality of pharmacies, and the common API module is configured to,
determine that the second prescription identifier is associated with the second pharmacy,
determine a second set of medical patient information required to fulfill the prescription at the second pharmacy based on the second configuration information, and
determine information associated with the second set of medical patient information required to fulfill the prescription is within the first profile, wherein information within the first profile is received from the medical patient based on the first prescription identifier.

3. The system of claim 2, wherein the first set of medical patient information and the second set of medical information are different.

4. The system of claim 2, wherein the consumer memory device is configured to receive information from the medical practitioner responsive to the common API module determining information associated with the first set of medical patient information required to fulfill the prescription is not within the first profile.

5. The system of claim 2, wherein the second prescription identifier is associated with a refill of the prescription associated with the first prescription identifier.

6. The system of claim 2, wherein the first set of medical patient information includes a legal name and address of the medical patient, and the second set of medical patient information includes a social security number of the patient.

7. The system of claim 1, wherein the presentation device is configured to:
present only the features within the first feature set associated with the first pharmacy to the medical patient, wherein a second pharmacy includes different features within a second feature set.

8. The system of claim 1, further including:
a pharmacy memory device configured to store pharmacy information associated with the plurality of pharmacies, the pharmacy information including a corresponding location and name of the first pharmacy and a second pharmacy.

9. The system of claim 9, wherein the communication device is configured to receive a transfer request to transfer the prescription from the first pharmacy to the second pharmacy responsive to determining the second pharmacy is the closest of the plurality of pharmacies to the medical patient.

10. The system of claim 9, wherein the common API module is configured to:
determine a second set of medical patient information required to fulfill the prescription at the second pharmacy based on the second configuration information;
determine that all the second set of medical patient information is within the first profile; and
automatically fulfill the prescription at the second pharmacy responsive to determining that all the second set of medical patient information is within the first profile.

11. A method for managing prescriptions, the method comprising:
receiving Application Programming Interfaces (API) from a plurality of pharmacies, the APIs requiring different sets of information to fulfill a prescription and the APIs including different feature sets, wherein the plurality of pharmacies are not associated with one another;
storing, at a configuration memory device, first configuration information for a first API associated with a first pharmacy and a first identifier associated with the first pharmacy, wherein the first pharmacy is one of the plurality of pharmacies;
storing, at a consumer memory device, a first profile associated with a medical patient;
receiving a first prescription identifier associated with a prescription for the medical patient;
determining that the first prescription identifier is associated with the first pharmacy;
determining a first set of medical patient information required to fulfill the prescription at the first pharmacy based on the first configuration information;
determining information associated with the first set of medical patient information required to fulfill the prescription is within the first profile;
presenting a first feature set associated with the first pharmacy based on the first configuration information; and
presenting the first set of medical patient information required to fulfill the prescription.

12. The method of claim 11, comprising:
receiving a second prescription identifier for the medical patient;
storing second configuration information for a second API associated with a second pharmacy and a second identifier associated with the second pharmacy, wherein the second pharmacy is one of the plurality of pharmacies;
determining that the second prescription identifier is associated with the second pharmacy;
determining a second set of medical patient information required to fulfill the prescription at the second pharmacy based on the second configuration information; and
determining information associated with the second set of medical patient information required to fulfill the prescription is within the first profile, wherein information within the first profile is received from the medical patient based on the first prescription identifier.

13. The method of claim 12, wherein the first set of medical patient information and the second set of medical information are different.

14. The method of claim 12, comprising:
receiving information from the medical practitioner responsive to the common API module determining information associated with the first set of medical patient information required to fulfill the prescription is not within the first profile.

15. The method of claim 12, wherein the second prescription identifier is associated with a refill of the prescription associated with the first prescription identifier.

16. The method of claim 12, wherein the first set of medical patient information includes a legal name and address of the medical patient, and the second set of medical patient information includes a social security number of the patient.

17. The method of claim 12, comprising:
presenting only the features within the first feature set associated with the first pharmacy to the medical patient, wherein a second pharmacy incudes different features within a second feature set.

18. The method of claim 11, comprising:
storing pharmacy information associated with the plurality of pharmacies, the pharmacy information including a corresponding location and name of the first pharmacy and a second pharmacy.

19. The method of claim 19, comprising:
receiving a transfer request to transfer the prescription from the first pharmacy to the second pharmacy responsive to determining the second pharmacy is the closest of the plurality of pharmacies to the medical patient.

20. The method of claim 19, comprising:
determining a second set of medical patient information required to fulfill the prescription at the second pharmacy based on the second configuration information;
determining that all the second set of medical patient information is within the first profile; and
automatically fulfilling the prescription at the second pharmacy responsive to determining that all the second set of medical patient information is within the first profile.
